(19) United States
(12) Patent Application Publication
(10) Pub. No.: US 2025/0069360 A1
(43) Pub. Date: Feb. 27, 2025

(54) MACHINE LEARNING MODEL SELECTION FOR CAMERA SYSTEMS

(71) Applicant: ROKU, INC., San Jose, CA (US)

(72) Inventors: Gregory GARNER, Key Colony Beach, FL (US); SOREN RIISE, San Jose, CA (US); PATRICK BROUILLETTE, Tempe, AZ (US); SUNIL RAMESH, Saratoga, CA (US); DAVID STERN, Los Gatos, CA (US); CARL SASSENRATH, Ukiah, CA (US); MICHAEL CUTTER, Golden, CO (US)

(21) Appl. No.: 18/455,758

(22) Filed: Aug. 25, 2023

(51) Int. Cl. G06V 10/44; G06V 10/764; G06V 20/52; G06V 30/262; H04N 23/63

(52) U.S. Cl. CPC G06V 10/44; G06V 10/764; G06V 20/52; G06V 30/274; H04N 23/633; G06V 2201/07

(57) ABSTRACT

Disclosed herein are system, apparatus, article of manufacture, method and/or computer program product embodiments, and/or combinations and sub-combinations thereof, for loading one or more machine learning models into a camera system to detect features of a video stream. An example embodiment operates by downloading a machine learning model from an application exchange service. The machine learning model may be pre-trained prior to loading and/or be trained to identify particular features. The camera system may install and/or retrain loaded machine learning models using captured images and/or user inputs. The camera system may also detect an unknown feature and obtain a classification label from an external system. Upon detecting a feature and/or an unknown feature, the camera system may transmit a camera detection notification to a user device and/or allow the user device to view the video stream.

### BACKGROUND

### Field

This disclosure is generally directed to camera systems implementing machine learning technology, and more particularly to loading machine learning models trained to detect features from video streams on to camera systems.

### SUMMARY

Provided herein are system, apparatus, article of manufacture, method and/or computer program product embodiments, and/or combinations and sub-combinations thereof, for loading one or more machine learning models into a camera system to detect features of a video stream. The camera system may load the machine learning models via an application exchange service. The machine learning models may be pre-trained prior to loading and/or be trained to identify particular features. The camera system may retrain loaded machine learning models using captured images and/or user inputs to provide additional fine-grain training specific to the camera system's environment. The camera system may also detect an unknown feature using a machine learning model and obtain a classification from an external system. The camera system may also generate a notification identifying this unknown feature and/or retrain the machine learning model using the classification.

An example embodiment operates by loading one or more machine learning models into a camera system to detect features of a video stream. The camera system may load the machine learning models via an application exchange service. For example, this may be an application store or machine learning model loader system accessible via a network connection. The machine learning models may be pre-trained prior to loading and/or be trained to identify particular features. Different machine learning models may be developed and trained to identify particular features of a video stream. For example, one machine learning model may be trained to identify a car type and model and/or recognize the alphanumeric characters of a license plate. Another machine learning model may identify the appearance of an animal and/or the type of animal that has appeared. Yet another machine learning model may identify a weather condition based on visual indicators from the video feed, such as the bending of a tree due to wind conditions. A machine learning model may also be trained to identify the absence of an object and/or to detect that an object is missing from property.

The camera system may load multiple machine learning models to detect multiple features. For example, a particular machine learning model may be used and/or applied to a video feed. A layer of the particular machine learning model can identify multiple classes. For example, a final layer can identify multiple classes or features. These may occupy a particular part of latent space. This may provide savings on computational costs. For example, a model may be trained to identify different classes or features.

The camera system may access one or more machine learning models via an application exchange service. The camera system can download and install selected machine learning models, which may be configured to identify particular features. A guided setup process may be provided with the camera system and/or accessible via a user device to provide recommendations for machine learning models to install. The recommended machine learning models may be adapted to the camera system's environment.

When a camera system loads a machine learning model, the camera system may also retrain the machine learning model. For example, the camera system may retrain the machine learning model using images captured by the camera system and/or a video stream from the camera system. This retraining may provide more accurate feature detection when the machine learning model monitors a later video feed. For example, a machine learning model may be trained to identify people. Retraining may allow the machine learning model to identify specific members of a particular household. In this manner, the machine learning model may be fine-tuned, weights may be tweaked, and/or classes may be augmented. The camera system may preserve private images and/or videos and prevent such data from leaving a home network. This may provide security and/or privacy while still fine-tuning the machine learning models used in the camera systems.

In addition to detecting the presence or absence of features in a video stream, the camera system may also perform an automated responsive action. For example, the camera system may generate a text message notification and/or transmit the text message notification to a user device. This may indicate the detection of a particular feature. For example, if a user has configured the camera system to detect the presence of bear and the camera system detects a bear, the camera system may generate a text message notification indicating that camera system has detected a bear. This type of notification and/or machine learning model may be relevant to some geographic areas but not others. The user and/or camera system may determine such relevance when selecting which machine learning models to load into the camera system. Upon detecting the feature, a user may be notified with a text message or an application push notification on a user device. The user may then view a video feed. This may also be applied in emergency situations. For example, when particular machine learning model is trained to identify an emergence situation, such as a child falling into a pool, the camera system may generate an alert or notification of the occurrence.

The camera system may be configured to automatically generate a home automation action in response to the detection of a feature. For example, a machine learning model may be trained to identify a particular car owned by a member of the household approaching the home. In response to this detection, the camera system may transmit a command to smart light bulbs in the house to illuminate. The camera system may perform additional home automation controls as well.

The camera system may detect unknown features. For example, an unknown feature may be a feature that a machine learning model loaded into the camera system is not yet configured to detect, label, and/or classify. The machine learning model, however, may still identify a pattern related to the pixels of the video stream. The machine learning model may classify this as an unknown feature. To classify and/or label this unknown feature, the camera system may present one or more frames of the video stream to an external system for classification. For example, this may be a system using a machine learning model trained on larger amounts of data and/or trained to identify different features. One such feature may be the unknown feature. The external system may be a user device. The user device may allow the user to provide a label for an unknown feature that has been detected.

For example, the camera system may capture a video feed that includes a skunk. The camera system, however, may have not been configured to identify and/or label a skunk. The machine learning model, however, may still identify the pixels as a pattern and identify this as an unknown feature. The camera system may then provide one or more images from the video stream to an external system to identify the unknown feature. For example, another machine learning model may be configured to identify skunks. Similarly, a user device may be configured to display the images to a user and to request a label from the user. For example, the user may provide a text input indicating that the unknown feature is a skunk. In subsequent detections of the skunk, the camera system may generate a notification and/or message indicating that a skunk has been detected. Similarly, the camera system may perform a home automation action, such as turning on a sprinkler system. The camera system may retrain its machine learning model to identify and/or detect subsequent instances of a skunk using the received classification label.

A user may provide detection instructions and/or corresponding response actions via a natural language command. For example, this may be a voice, audio, and/or text command to the camera system. Upon receiving such a command, the camera system may load one or more relevant machine learning models and/or set a configuration to perform an action upon detecting a feature corresponding to the machine learning model. In this manner, the camera system may analyze a natural language command to select a machine learning model and implement automated actions at the request of a user.

### BRIEF DESCRIPTION OF THE FIGURES

The accompanying drawings are incorporated herein and form a part of the specification.

FIG. 1 illustrates a block diagram of a multimedia environment, according to some embodiments.

FIG. 2 illustrates a block diagram of a streaming media device, according to some embodiments.

FIG. 3 illustrates a block diagram of a camera system environment, according to some embodiments.

FIG. 4 illustrates a block diagram of a camera system detecting features, according to some embodiments.

FIG. 5A illustrates a flowchart depicting a method for loading a machine learning model into a camera system, according to some embodiments.

FIG. 5B illustrates a flowchart depicting a method for detecting a feature from a camera system using a loaded a machine learning model, according to some embodiments.

FIG. 6 illustrates a flowchart depicting a method for identifying an unknown feature using a machine learning model, according to some embodiments.

FIG. 7 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for loading one or more machine learning models into a camera system to detect features of a video stream.

Some camera systems have been used to detect features and/or monitor households. For example, such camera systems have been placed within homes as well as outdoors to monitor activity related to a home. Such camera systems, however, have limited capabilities and have limited success detecting different features in video streams. Additionally, the level of detail that such camera systems can provide is often limited. For example, while a camera system may detect the presence of people standing near the camera system, such camera systems cannot provide further details or identify different classes of visual data.

To address such camera system limitations, embodiments described herein describe a camera system that may load one or more machine learning models. This loading may include training and/or retraining the machine learning models to tune detectability to features relevant to the camera system's environment. For example, one camera system may load one or more machine learning models while another camera system may load one or more other machine learning models. These machine learning models may have been trained to detect features in the environment of the camera system. The camera systems may be integrated into a home network. The home network may include a multimedia environment. For example, using the multimedia environment, a user may view a camera feed and/or a video stream from a camera system. Similarly, the user may receive a notification via components of the multimedia environment upon detection of a feature by the camera system. The camera system may also perform home automation actions in the multimedia environment. For example, a display device may be turned on or off based on detection of a feature by the camera system.

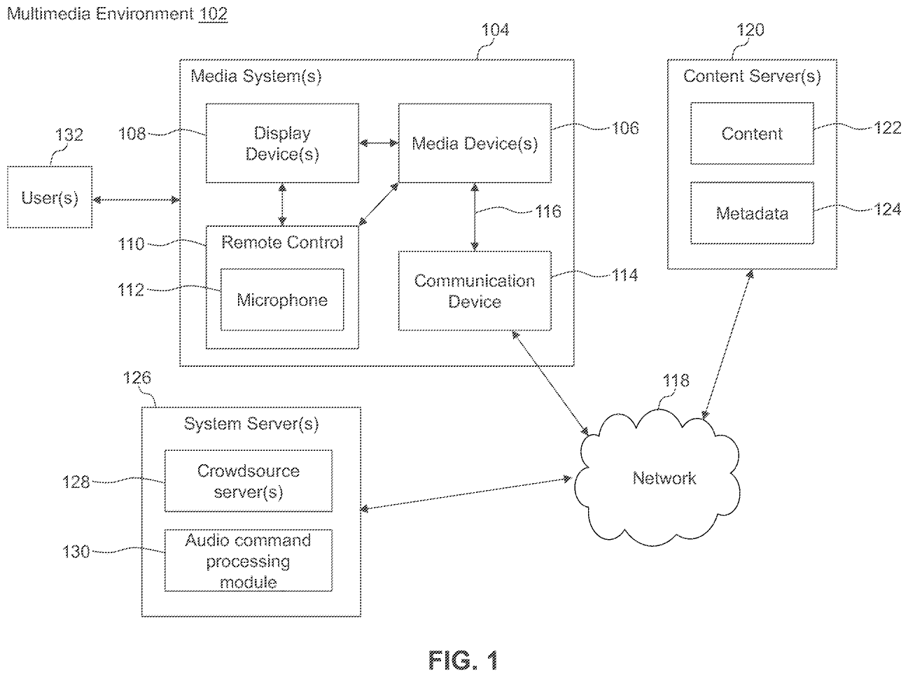

Various embodiments of this disclosure may be implemented using and/or may be part of a multimedia environment 102 shown in FIG. 1. It is noted, however, that multimedia environment 102 is provided solely for illustrative purposes, and is not limiting. Embodiments of this disclosure may be implemented using and/or may be part of environments different from and/or in addition to the multimedia environment 102, as will be appreciated by persons skilled in the relevant art(s) based on the teachings contained herein. An example of the multimedia environment 102 shall now be described.

### Multimedia Environment

FIG. 1 illustrates a block diagram of a multimedia environment 102, according to some embodiments. In a non-limiting example, multimedia environment 102 may be directed to streaming media. However, this disclosure is applicable to any type of media (instead of or in addition to streaming media), as well as any mechanism, means, protocol, method and/or process for distributing media. For example, the multimedia environment 102 may implement and/or connect to camera systems. The streaming may include streaming video streams and/or camera feeds from the camera systems to one or more display devices and/or user devices.

The multimedia environment 102 may include one or more media systems 104. A media system 104 could represent a family room, a kitchen, a backyard, a home theater, a school classroom, a library, a car, a boat, a bus, a plane, a movie theater, a stadium, an auditorium, a park, a bar, a restaurant, or any other location or space where it is desired to receive and play streaming content. User(s) 132 may operate with the media system 104 to select and consume content. This may include viewing video streams from a camera system. Each media system 104 may include one or more media devices 106 each coupled to one or more display devices 108. It is noted that terms such as “coupled,” “connected to,” “attached,” “linked,” “combined” and similar terms may refer to physical, electrical, magnetic, logical, etc., connections, unless otherwise specified herein.

Media device 106 may be a streaming media device, DVD or BLU-RAY device, audio/video playback device, cable box, and/or digital video recording device, to name just a few examples. The media device 106 may include and/or be coupled to a camera system. Display device 108 may be a monitor, television (TV), computer, smart phone, tablet, wearable (such as a watch or glasses), appliance, internet of things (IoT) device, and/or projector, to name just a few examples. Media device 106 can be a part of, integrated with, operatively coupled to, and/or connected to its respective display device 108. A camera system may also communicate with and/or provide data to a display device 108.

Each media device 106 may be configured to communicate with network 118 via a communication device 114. The communication device 114 may include, for example, a cable modem or satellite TV transceiver. The media device 106 may communicate with the communication device 114 over a link 116, wherein the link 116 may include wireless (such as WiFi) and/or wired connections.

The network 118 can include, without limitation, wired and/or wireless intranet, extranet, Internet, cellular, Bluetooth, infrared, and/or any other short range, long range, local, regional, global communications mechanism, means, approach, protocol and/or network, as well as any combination(s) thereof.

Media system 104 may include a remote control 110. The remote control 110 can be any component, part, apparatus and/or method for controlling the media device 106 and/or display device 108, such as a remote control, a tablet, laptop computer, smartphone, wearable, on-screen controls, integrated control buttons, audio controls, or any combination thereof, to name just a few examples. The remote control 110 wirelessly communicates with the media device 106 and/or display device 108 using cellular, Bluetooth, infrared, etc., or any combination thereof. The remote control 110 may include a microphone 112, which is further described below.

The multimedia environment 102 may include a plurality of content servers 120 (also called content providers, channels or sources 120). Although only one content server 120 is shown in FIG. 1, in practice the multimedia environment 102 may include any number of content servers 120. Each content server 120 may be configured to communicate with network 118.

Each content server 120 may store content 122 and metadata 124. Content 122 may include any combination of music, videos, movies, TV programs, multimedia, images, still pictures, text, graphics, gaming applications, advertisements, programming content, public service content, government content, local community content, software, and/or any other content or data objects in electronic form. Content may include machine learning models to be loaded into a camera system.

Metadata 124 comprises data about content 122. For example, metadata 124 may include associated or ancillary information indicating or related to writer, director, producer, composer, artist, actor, summary, chapters, production, history, year, trailers, alternate versions, related content, applications, and/or any other information pertaining or relating to the content 122. Metadata 124 may also or alternatively include links to any such information pertaining or relating to the content 122. Metadata 124 may also or alternatively include one or more indexes of content 122, such as but not limited to a trick mode index.

The multimedia environment 102 may include one or more system servers 126. The system servers 126 may operate to support the media devices 106 from the cloud. It is noted that the structural and functional aspects of the system servers 126 may wholly or partially exist in the same or different ones of the system servers 126.

The media devices 106 may exist in thousands or millions of media systems 104. Accordingly, the media devices 106 may lend themselves to crowdsourcing embodiments and, thus, the system servers 126 may include one or more crowdsource servers 128.

For example, using information received from the media devices 106 in the thousands and millions of media systems 104, the crowdsource server(s) 128 may identify similarities and overlaps between closed captioning requests issued by different users 132 watching a particular movie. Based on such information, the crowdsource server(s) 128 may determine that turning closed captioning on may enhance users' viewing experience at particular portions of the movie (for example, when the soundtrack of the movie is difficult to hear), and turning closed captioning off may enhance users' viewing experience at other portions of the movie (for example, when displaying closed captioning obstructs critical visual aspects of the movie). Accordingly, the crowdsource server(s) 128 may operate to cause closed captioning to be automatically turned on and/or off during future streamings of the movie.

The system servers 126 may also include an audio command processing module 130. As noted above, the remote control 110 may include a microphone 112. The microphone 112 may receive audio data from users 132 (as well as other sources, such as the display device 108). The media device 106 may be audio responsive, and the audio data may represent verbal commands from the user 132 to control the media device 106 as well as other components in the media system 104, such as the display device 108.

The audio data received by the microphone 112 in the remote control 110 is transferred to the media device 106, which is then forwarded to the audio command processing module 130 in the system servers 126. The audio command processing module 130 may operate to process and analyze the received audio data to recognize the user 132′s verbal command. The audio command processing module 130 may then forward the verbal command back to the media device 106 for processing. As further explained below, a user 132 may provide a verbal command to set the detection of a feature and/or to set a machine learning model for installation. The user 132 may also set a home automation action corresponding to a feature detected via the camera system.

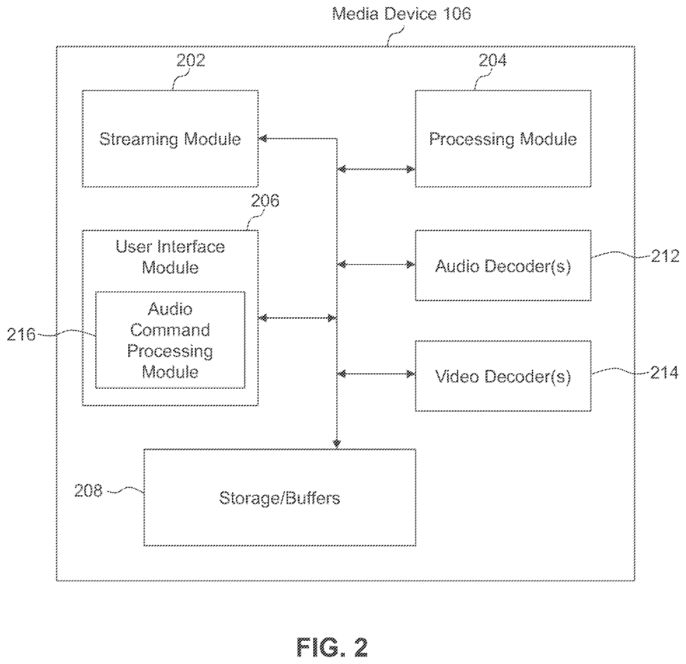

The audio data may be alternatively or additionally processed and analyzed by an audio command processing module 216 in the media device 106 (see FIG. 2). The media device 106 and the system servers 126 may then cooperate to pick one of the verbal commands to process (either the verbal command recognized by the audio command processing module 130 in the system servers 126, or the verbal command recognized by the audio command processing module 216 in the media device 106).

FIG. 2 illustrates a block diagram of an example media device 106, according to some embodiments. Media device 106 may include a streaming module 202, processing module 204, storage/buffers 208, and user interface module 206. As described above, the user interface module 206 may include the audio command processing module 216. Media device 106 may interface with a camera system, may include a camera system, and/or may be included in a camera system.

The media device 106 may also include one or more audio decoders 212 and one or more video decoders 214.

Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OP1a, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to H.263, H.264, H.265, AVI, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

Now referring to both FIGS. 1 and 2, the user 132 may interact with the media device 106 via, for example, the remote control 110. For example, the user 132 may use the remote control 110 to interact with the user interface module 206 of the media device 106 to select content, such as a movie, TV show, music, book, application, game, etc. The streaming module 202 of the media device 106 may request the selected content from the content server(s) 120 over the network 118. The content server(s) 120 may transmit the requested content to the streaming module 202. The media device 106 may transmit the received content to the display device 108 for playback to the user 132. The content and/or playback may be a video stream generated by a camera system.

In streaming embodiments, the streaming module 202 may transmit the content to the display device 108 in real time or near real time as it receives such content from the content server(s) 120. In non-streaming embodiments, the media device 106 may store the content received from content server(s) 120 in storage/buffers 208 for later playback on display device 108.

### Camera Systems in a Home Network

Referring to FIG. 1, media device 106 may interface with a camera system, may include a camera system, and/or may be included in a camera system. By communicating with one or more servers, the camera systems may load one or more machine learning models trained to detect particular features in a video stream. Upon detecting a particular feature, the camera system and/or the media device 106 may transmit a notification to a user device, such as display device 108. Using display device 108, the user 132 may view the video stream captured by the camera system and/or media device 106. The camera system may implement one or more machine learning models, which may be pre-trained, pre-configured, and/or tuned to identify particular features. The camera system may additionally retrain a loaded machine learning model. For example, the machine learning model may be retrained using images captured by the video stream and/or additional classification data. The machine learning model may also detect an unknown feature and obtain a classification for this unknown feature. The machine learning model may be retrained to identify instances of this unknown feature in later video streams.

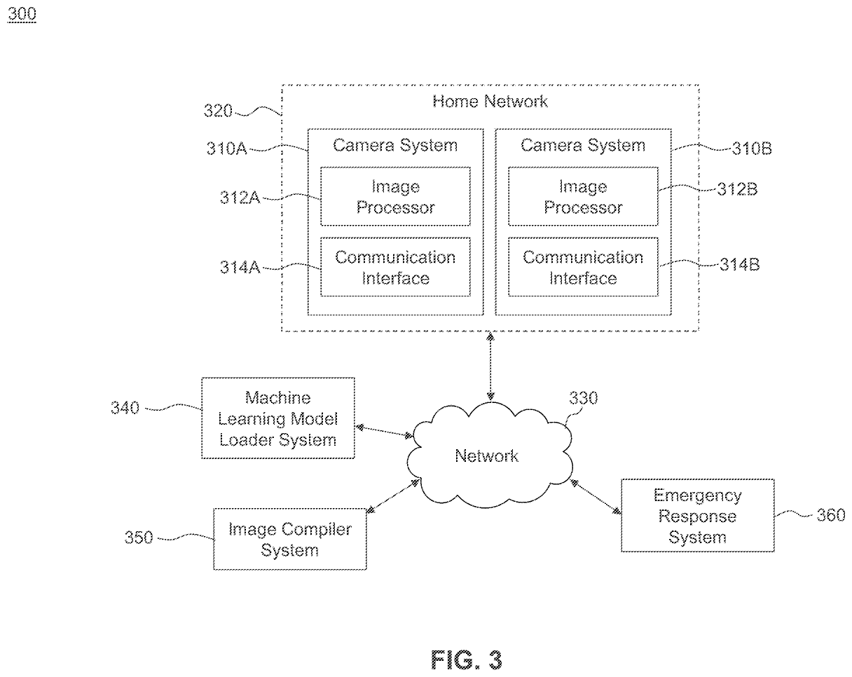

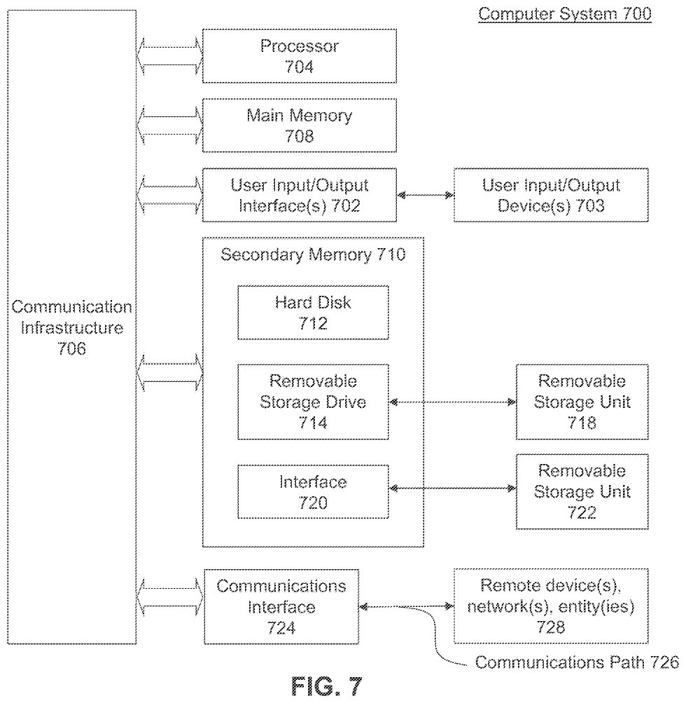

FIG. 3 illustrates a block diagram of a camera system environment 300, according to some embodiments. Camera system environment 300 includes camera systems 310A, 310B, a home network 320, network 330, machine learning model loader system 340, image compiler system 350, and/or emergency response system 360. Camera systems 310 may include one or more camera, processors, memories, and/or may implement aspects of computer system 700 as described with reference to FIG. 7. As previously explained, camera system 310 may also interface with, communicate with, be implemented in, and/or implement media device 106. For example, a user may install one or more camera systems 310 in and/or around a home to monitor one or more video feeds around the house.

To perform the video feed monitoring, a camera system 310 may include an image processor 312 and/or a communication interface 314. The image processor 312 may be a processor with preloaded machine learning models and/or be configured to install and/or implement one or more machine learning models. The machine learning models may be trained to detect particular features in a video stream. For example, a particular machine learning model may be trained to detect a bear or to detect a child standing by a pool. The machine learning model may be trained to identify a car type and model and/or recognize the alphanumeric characters of a license plate. Another machine learning model may identify the appearance of an animal and/or the type of animal that has appeared. Yet another machine learning model may identify a weather condition based on visual indicators from the video feed, such as the bending of a tree due to wind conditions. A machine learning model may be trained to identify the absence of an object and/or to detect that an object is missing from property.

Image processor 312 may communicate with one or more lenses, aperture elements, electronic sensors, and/or camera elements to receive image and/or video stream data. Image processor 312 may then monitor and/or analyze the image and/or video stream data using the one or more loaded machine learning models. Image processor 312 may detect one or more features corresponding to the loaded machine learning models. Upon detecting one or more of these features, image processor 312 may generate a camera detection notification. This camera detection notification may indicate the detection of the particular feature. For example, if a bear is detected by a machine learning model configured to detect bears in a video stream, image processor 312 may generate a camera detection notification indicating that a bear has been detected. Camera system 310 and/or image processor 312 may transmit the camera detection notification to a user device and/or a display device 108 as described with reference to FIG. 1.

Camera system 310 may also set and/or generate a response command to perform a home automation action in response to detecting a feature. The response command may be transmitted to a home automation system via communication interface 314 and/or home network 320. Communication interface 314 may be similar to communication interface 724 as described with reference to FIG. 7. Home network 320 may include any combination of routers, switches, access points, LANs, WANs, the Internet, network 118, and/or include wired and/or wireless communications. Home network 320 may include one or more home automation systems which may be communicatively coupled to one or more camera systems 310. These home automation systems may include light control systems, temperature control systems, locking mechanisms, audio alarms or sirens, window or blinds controllers, and/or other smart home electronics. In response to identifying a particular feature, camera system 310 may transmit a command to a home automation system to perform a corresponding action previously set by the user. For example, in response to detecting heavy winds based on a visual indication such as the bending of trees, camera system 310 may transmit a command to close a garage door. This command may be transmitted via home network 320 and/or network 330.

To load one or more machine learning models onto a camera system 310, the camera system may access machine learning model loader system 340. This may occur via network 330, which may be similar to network 118. Machine learning model loader system 340 may be an application exchange platform and/or an app store accessible by camera system 310. Machine learning model loader system 340 may be executed on one or more servers. As further explained below, camera system 310 may access machine learning model loader system 340 based on a user selection of a particular machine learning model to load into the camera system 310. For example, one or more machine learning models may have been recommended to the user for loading. The user may browse and/or select one or more machine learning models to load from machine learning model loader system 340. Machine learning model loader system 340 may include a database and/or caches of machine learning model data, including training data and/or weighting data to train machine learning models. Machine learning model loader system 340 may manage pre-trained machine learning models that have been trained using such data. Camera system 310 may then download these pre-trained machine learning models from machine learning model loader system 340.

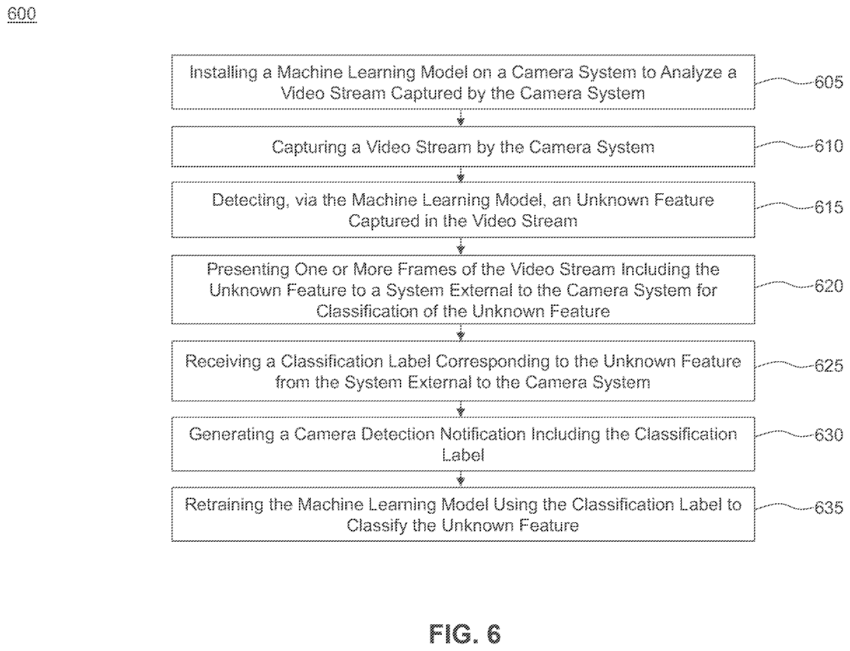

Camera system 310 may also communicate with image compiler system 350. This interaction may occur when camera system 310 encounters an unknown feature. Image compiler system 350 may be executed on one or more servers. Image compiler system 350 and machine learning model loader system 340 may be implemented in the same system. When camera system 310 encounters an unknown feature as further described with reference to FIG. 6, camera system 310 may provide one or more images from a video feed to image compiler system 350. Image compiler system 350 may include a more robust machine learning model that may have been trained to identify more classes and/or to detect more features relative to a machine learning model loaded into camera system 310. When providing the images to image compiler system 350, image compiler system 350 may generate labels and/or classify features that the camera system 310 was not capable of identifying.

For example, camera system 310 may detect a pattern of symbols and/or pixels in a video stream. Despite recognizing the presence of a pattern, the machine learning model may not have been able to provide a label to this detected feature. Camera system 310 may provide one or more images to image compiler system 350. Image compiler system 350 may be trained to recognize that the image include a skunk. The image compiler system 350 may return this classification label to the camera system 310. The camera system 310 may then retrain one or more of its machine learning models to identify this feature in future video streams. In this manner, image compiler system 350 may provide more robust training and/or classification which may aid camera system 310 in identifying objects relevant to the environment of camera system 310.

This may also provide memory and/or computational efficiencies by not pre-loading feature detection functionality that is not relevant to the environment of the camera system 310. For example, while image compiler system 350 may be capable of detecting panda bears in images, this detection may not be relevant to a camera system 310 situated in Montana and is only interested in detecting brown bears. Should circumstances change, however, camera system 310 may utilize the more robust classification provided by image compiler system 350 to retrain its own machine learning models.

Camera system 310 may also communicate with an emergency response system 360. This may occur when a response action to a detected feature is to contact an emergency response organization, such as a police system, firefighting system, and/or paramedic system. Camera system 310 may be configured to communicate with these systems when detecting an emergency situation. For example, camera system 310 may include a video stream that has a portion of the stream capturing the front yard of a neighboring house across the street. The front yard may catch fire. Camera system 310 may detect this fire via a machine learning model configured to identify fire in a video stream. In response, camera system 310 may transmit an alert message to emergency response system 360 to request emergency assistance. This may be a data packet and/or API call transmitted via network 330. This may occur for detected features related to Amber alerts and/or with recognition of criminals. This may also occur if camera system 310 detects a thief stealing property. For Amber alerts, data related to a particular vehicle and/or a child may be pushed to camera system 310. Camera system 310 may retrain a machine learning model with this data to detect features specific to an Amber alert.

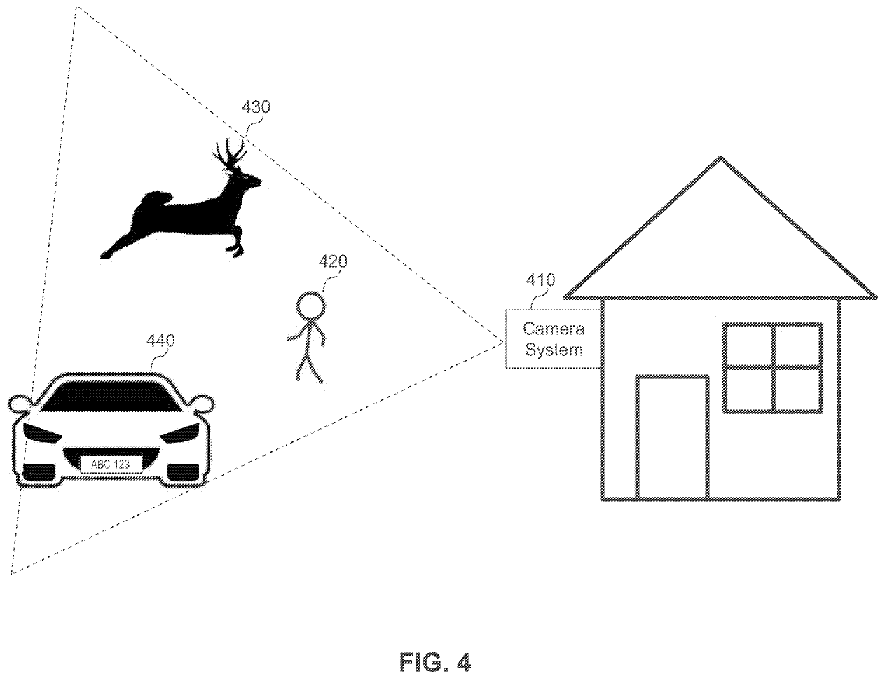

FIG. 4 illustrates a block diagram of a camera system 410 detecting features, according to some embodiments. Camera system 410 may be similar to camera system 310 as described with reference to FIG. 3. Camera system 410 may be attached to a building or a house. Camera system 410 may capture images, camera feeds, video frames, and/or video streams, from the interior and/or the exterior of the house. One or more camera systems 410 may be placed in, on, and/or around the house. The house may implement home network 320 to interconnect camera systems 410 and/or to facilitate communications between the camera systems 410. Camera systems 410 may also be placed on buildings, boats, cruise ships, and/or other locations.

As previously explained, camera system 410 may download and/or install one or more machine learning models trained to detect features in a video stream. The machine learning models may have been pre-trained to detect these features. Camera system 410 trains and/or retrains the one or more machine learning models. Multiple machine learning models may be loaded into camera system 410 to detect features. One machine learning model may be trained to identify multiple features.

Camera system 410 may include one or more machine learning models configured to detect people 420, animals 430, vehicles 440, and/or other features. Camera system 410 may detect static and/or dynamic objects. Camera system 410 may also detect varying degrees of detail and/or granularity with respect to people 420, animals 430, vehicles 440, and/or other features. For example, camera system 410 may implement facial recognition and/or determine an identity of a person. This may be performed based on re-training of a machine learning model by camera system 410. For example, a user may use family photos to retrain the machine learning model to identify and/or label members of the family. Similarly, camera system 410 may identify animals 430. Camera system 410 may identify specific species and/or genus details related to an animal. Similarly, camera system 410 may detect vehicles 440. The vehicles 440 may be moving and/or may be static. Camera system 410 may identify a type, make, and/or model of vehicle 440. Camera system 410 may also identify a license plate and/or characters of the license plate. Camera system 410 may implement an optical character recognition process and/or may apply another machine learning algorithm configured to identify the characters. For example, camera system 410 may recognize a semantic meaning corresponding to textual characters identified via natural language processing.

The detected features may include events and/or actions. For example, camera system 410 may detect static and/or dynamic objects. Camera system 410 may identify changes between frames of a video stream. For example, camera system 410 may identify a child standing near a pool. This may not generate an alert or a notification message. The child, however, may fall into the pool. Camera system 410 may detect the movement and/or the absence of the child in subsequent video frames. In this case, camera system 410 may generate an alert, message, and/or home automation command as previously set. In this manner, camera system 410 may also detect the absence of an object as a feature.

In addition to detecting features, camera system 410 may also recall and/or present one or more save video frames at the request of the user. For example, if camera system 410 has captured footage of animal 430, a user may request that camera system 410 provide those images and/or footage. This may be a natural language commands to camera system 410. Camera system 410 may then retrieve the stored images and/or present these images to a user device. The user may opt-in to providing those images to image compiler system 350 for additional training.

Camera system 410 may detect an unknown feature as explained in this description. Camera system 410 may generate a notification that indicates than an unknown feature has been detected. This may occur even if a classification label for the unknown feature has not been determined. Camera system 410 may transmit a home automation command in response to detecting unknown features as well. This may occur even when there is no classification label associated with the unknown feature.

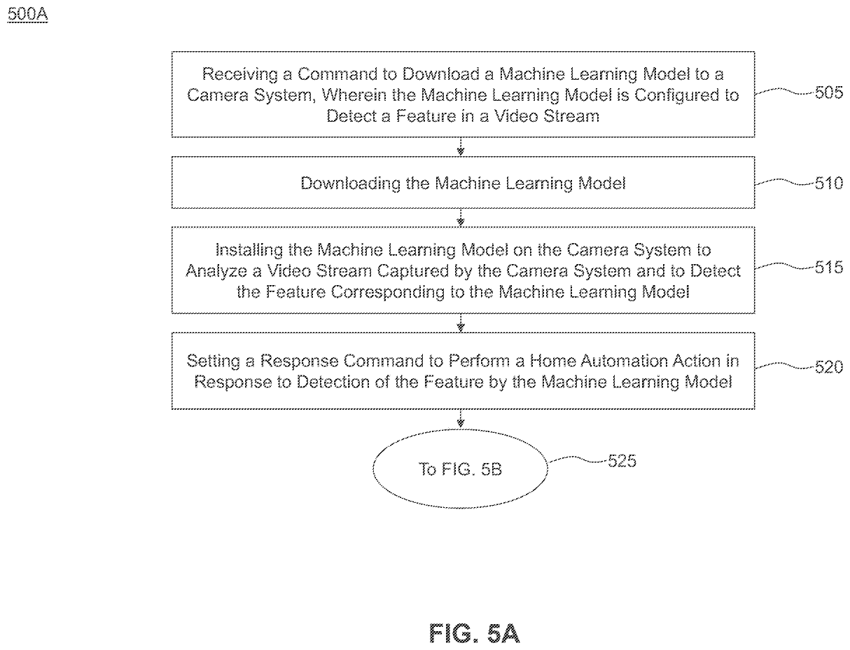

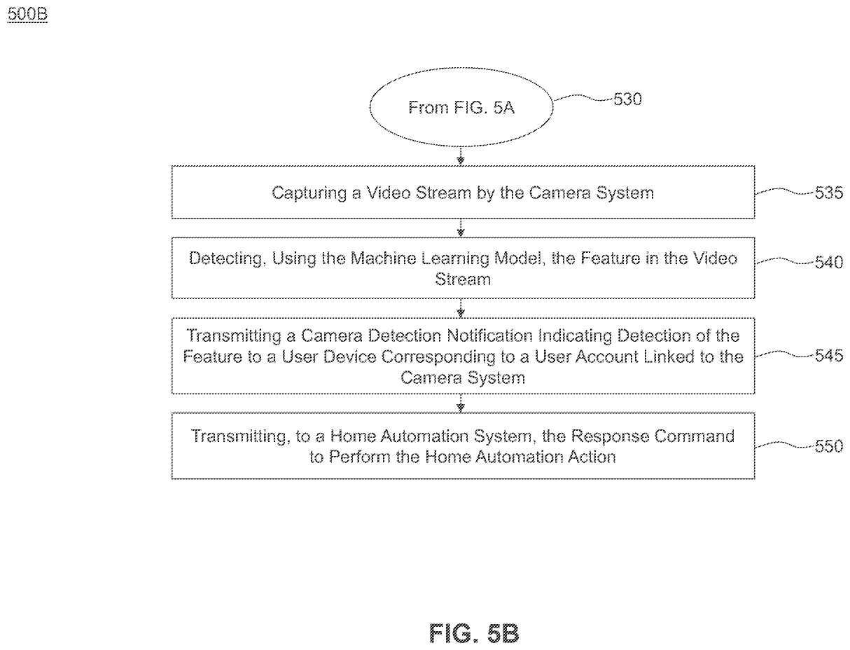

FIG. 5A illustrates a flowchart depicting a method 500A for loading a machine learning model into a camera system, according to some embodiments. Method 500A can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5A, as will be understood by a person of ordinary skill in the art.

Method 500A shall be described with reference to FIG. 3. However, method 500A is not limited to that example embodiment. In an embodiment, a camera system 310 may load a machine learning model. This may include downloading, installing, training, and/or retraining the machine learning model. The machine learning model may be downloaded from a machine learning model loader system 340, which may host an application exchange, app store, and/or app marketplace. While method 500A is described with reference to camera system 310, method 500A may be executed on any computing device, such as, for example, the computer system described with reference to FIG. 7 and/or processing logic that may comprise hardware (e.g., circuitry, dedicated logic, programmable logic, microcode, etc.), software (e.g., instructions executing on a processing device), or a combination thereof.

At 505, camera system 310 receives a command to download a machine learning model to camera system 310. The machine learning model is configured to detect a feature in a video stream. Camera system 310 may receive a voice or text command that instructs camera system 310 to perform the download. This may be a multimodal command or invocation. The user may provide a natural language instruction to camera system 310. For example, the user may indicate that they would like to detect the presence of a particular animal. The user may then provide a voice command to camera system 310 such as “Send me a text message when you detect a deer.” Camera system 310 may use a natural language processing service and/or a machine learning model catalog to identify a particular machine learning model trained to identify deer. The machine learning model catalog may be part of machine learning model loader system 340 and/or may be accessed via an API. Camera system 310 may parse audio and/or text commands to identify one or more machine learning models to install based on the user's instructions.

A user may browse a machine learning model catalog and select a machine learning model for installation. For example, this may include browsing a website and/or using a web application installed on a user device to identify a machine learning model. This may appear as a function or capability that is installable on camera system 310. For example, the catalog may include options selectable as graphical user interface objects such as “Add the ability to track vehicles to your camera” or “Add the ability to detect missing items for your lawn.” Upon the selection of the functionality, camera system 310 may be instruction to download a corresponding machine learning model.

Camera system 310 may also be configured to recommend one or more machine learning models for user selection. Camera system 310 may use metadata and/or data related to the environment to recommend one or more machine learning models for loading. For example, camera system 310 may detect the presence of a pool or body of water in a field of view. A user may tour their homes and/or capture videos in and/or around their home. A user may be guided to perform this capture via an application installed on a user device. Camera system 310 may identify features of the home to recommend a machine learning model. Camera system 310 may identify one or more machine learning models and/or abilities to recommend based on this identification. For example, camera system 310 may recommend the ability to detect a person falling into the body of water and/or to generate an alert upon detection. The recommendation may include a recommendation to purchase additional camera systems 310 or home automation systems and/or placement for additional camera systems 310. The tour data may also be used to generate a simulation and/or view of the house.

At 510, camera system 310 downloads the machine learning model. Camera system 310 may download the machine learning model from machine learning model loader system 340. As previously explained, this may include downloading the machine learning model from an application exchange, app store, and/or app marketplace hosted on the machine learning model loader system 340.

At 515, camera system 310 installs the machine learning model. Via the installation, camera system 310 is then able to analyze a captured video stream and detect the feature corresponding to the machine learning model. The installation may include storing executable instructions in memory of camera system 310 and/or modifying a machine learning engine in camera system 310 with parameters and/or weights downloaded from machine learning model loader system 340.

Camera system 310 retrains a downloaded machine learning model as part of the installation process. For example, this retraining may include modifying machine learning model weights and/or parameters. The retraining may adapt and/or fine-tune a downloaded machine learning model based on an environment for camera system 310. For example, the retaining may use images captured by camera system 310 to identify objects that will likely be in the field of view of camera system 310. This may include facial recognition for members of a household.

At 520, camera system 310 sets a response command to perform a home automation action in response to detection of the feature by the machine learning model. For example, camera system 310 may transmit one or more commands to a home automation system in response to detecting a feature. The home automation systems may include light control systems, temperature control systems, locking mechanisms, audio alarms or sirens, window or blinds controllers, and/or other smart home electronics. A user may link camera system 310 to one or more of these home automation systems via home network 320. Camera system 310 may also configure the home automation systems based on a natural langue command provided by the user. For example, the user may provide a voice command to camera system 310 that is “Turn on my sprinklers when you detect a deer in the yard.” Camera system 310 may parse this natural language command to identify a machine learning model for detecting deer. Camera system 310 may also transmit configuration instructions to a sprinkler management system to establish communications. The established communication channel may be used to perform the action when a deer is detected by camera system 310.

At 525, camera system 310 proceeds to method 500B as described with reference to FIG. 5B. Camera system 310 may execute method 500A multiple times to load multiple machine learning models.

FIG. 5B illustrates a flowchart depicting a method 500B for detecting a feature from a camera system using a loaded a machine learning model, according to some embodiments. Method 500B can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5B, as will be understood by a person of ordinary skill in the art.

Method 500B shall be described with reference to FIG. 3 and FIG. 5A. However, method 500B is not limited to that example embodiment. In an embodiment, a camera system 310 may apply a loaded machine learning model. This may include monitoring a video stream captured by the camera system 310 and/or detecting a particular feature using the machine learning model. While method 500B is described with reference to camera system 310, method 500B may be executed on any computing device, such as, for example, the computer system described with reference to FIG. 7 and/or processing logic that may comprise hardware (e.g., circuitry, dedicated logic, programmable logic, microcode, etc.), software (e.g., instructions executing on a processing device), or a combination thereof.

At 530, camera system 310 executes method 500A as described with reference to FIG. 5A. For example, this may include downloading and/or installing a machine learning model onto camera system 310.

At 535, camera system 310 captures a video stream. For example, camera system 310 may capture one or more video frames using one or more lenses, aperture elements, electronic sensors, and/or camera elements. Camera system 310 may convert the captured images into digital data for analysis by the machine learning model.

At 540, camera system 310 detects, using the machine learning model, a feature in the video stream. This feature may correspond to a feature that the machine learning model was previously trained to detect. As previously explained, the machine learning model may have been trained, pretrained, and/or retrained to detect the particular feature. Additionally, the feature may include detecting the presence of an object, the appearance of an object, the absence of an object, the disappearance of an object, events, and/or changes between multiple video stream frames. These features may be predefined. The machine learning model may generate a digital indication of the feature. This may include bounding boxes and/or modifications to one or more frames of the video stream as well to identify the detected feature.

Camera system 310 may use a time slicing technique. For example, camera system 310 may use multiple processors to process images in parallel. Camera system 310A may receive data from camera system 310B which may aid in detecting a feature. Camera system 310A may load a first set of machine learning models for processing certain features while camera system 310B may load a second set of machine learning models for processing other features.

At 545, camera system 310 transmits a camera detection notification indicating detection of the feature to a user device corresponding to a user account linked to the camera system 310. For example, a user may have registered a user account with the camera system 310. The user may also log in to an application on a user device using user account credentials. This may provide a link for the user device to receive a notification from a camera detection system 310. For example, this notification may appear on a smartphone and/or a display device. By interacting with the notification, the user may view the video stream captured by camera system 310.

At 550, camera system 310 may transmit, to a home automation system, the response command to perform the home automation action. The user may have previously set the home automation action as described in 520. The home automation action may then perform the designated action.

FIG. 6 illustrates a flowchart depicting a method 600 for identifying an unknown feature using a machine learning model, according to some embodiments. Method 600 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 6, as will be understood by a person of ordinary skill in the art.

Method 600 shall be described with reference to FIG. 3. However, method 600 is not limited to that example embodiment. In an embodiment, a camera system 310 may apply a loaded machine learning model. This may include monitoring a video stream captured by the camera system 310 and/or detecting a particular feature using the machine learning model. The machine learning model may also detect an unknown feature or a feature that it is not yet capable of labeling or not yet configured to label. The machine learning model may identify an unknown feature that it is not yet capable of classifying or not yet configured to classify. While method 600 is described with reference to camera system 310, method 600 may be executed on any computing device, such as, for example, the computer system described with reference to FIG. 7 and/or processing logic that may comprise hardware (e.g., circuitry, dedicated logic, programmable logic, microcode, etc.), software (e.g., instructions executing on a processing device), or a combination thereof.

At 605, camera system 310 installs a machine learning model. The machine leaning model is configured to analyze one or more video streams captured by camera system 310. This may occur in a manner similar to 505, 510, and/or 515 as described with reference to FIG. 5A.

At 610, camera system 310 captures a video stream. This may occur in a manner similar to 535 as described with reference to FIG. 5B.

At 615, camera system 310 detects, via the machine learning model, an unknown feature captured in the video stream. For example, camera system 310 may have been monitoring video streams to detect features. The detected features may correspond to those that the machine learning model was previously trained to detect. While performing this monitoring, the machine learning model may detect a pattern related to the pixels of the video stream. The machine learning model may not yet be configured to detect, label, and/or classify this pattern in the images. The machine learning model, however, may still detect the pattern. This may be due to a repeated occurrence of the feature in the video stream. Upon recognizing this pattern, the machine learning model may classify the pattern as an unknown feature.

At 620, camera system 310 presents one or more frames of the video stream including the unknown feature to a system external to the camera system 310 for classification of the unknown feature. For example, camera system 310 may transmit one or more frames of the video stream to image compiler system 350 and/or a user device. Image compiler system 350 may include a more robust machine learning model that may have been trained to identify more classes and/or to detect more features relative to the machine learning model loaded into camera system 310. The presentation of the one or more frames to image compiler system 350 may yield a classification and/or label that the machine learning model loaded into camera system 310 may have not been configured to identify. When presenting the one or more frames to image compiler system 350, image compiler system 350 may generate labels for and/or classify the unknown features

The external system may be a user device. The user device may be and/or include a display device configured to display the one or more frames of the video stream. The user device may be configured to display the images to a user and to request a label from the user. The user device may allow the user to provide a label for an unknown feature that has been detected. The user may provide a text input and/or an audio input to label the unknown feature. For example, the user may provide a text input indicating that the unknown feature is a skunk. Camera system 310 may provide a suggested classification label to the user device. The suggested classification label may have been generated by camera system 310 and/or by image compiler system 350. The user using the user device may confirm whether the suggested classification label is correct. If so, the camera system 310 may use this suggested classification label. If not, camera system 310 may provide another suggested classification label and/or request that the user provide a text input to label the unknown feature.

At 625, camera system 310 receives the classification label corresponding to the unknown feature from the system external to camera system 310. In the scenario where image compiler system 350 is used, image compiler system 350 may transmit the classification label to camera system 310. This may occur over network 330. When the user device provides the classification label, the user device may transmit the classification label to camera system 310 via home network 320 and/or network 330. Upon receiving the classification label, camera system 310 may store the label in memory. Camera system 310 may associate the classification label with the one or more frames of the video stream. This may allow camera system 310 to generate labeled training data.

At 630, camera system 310 generates a camera detection notification including the classification label. Camera system 310 may transmit the camera detection notification to a user device with the classification label. The generation and/or transmission may occur in a manner similar to 545. For example, when image compiler system 350 has provided the classification label, the user receiving the classification label may be informed of the detection of the unknown feature with the classification label. The user may view the classification label and/or camera detection notification on a user device. In this manner, the user may be informed of an unknown feature even if the user had not previously commanded camera system 310 to detect such a feature. The user may also provide a correction to the classification label if it is inaccurate. Camera system 310 may preserve this correction and/or generate labeled training with this corrected classification label.

At 635, camera system 310 retrains the machine learning model using the classification label to classify the unknown feature. For example, camera system 310 may use the labeled training data generated using the classification label. The retraining may change weights and/or parameters of the machine learning model. This may aid in the detection of the unknown feature in subsequent video streams. When detecting the unknown feature, the machine learning model may use the classification label to identify the unknown feature. Similarly, subsequently generated camera detection notification messages may also include the classification label.

### Example Computer System

Various embodiments may be implemented, for example, using one or more well-known computer systems, such as computer system 700 shown in FIG. 7. For example, the media device 106 may be implemented using combinations or sub-combinations of computer system 700. Also or alternatively, one or more computer systems 700 may be used, for example, to implement any of the embodiments discussed herein, as well as combinations and sub-combinations thereof.

Computer system 700 may include one or more processors (also called central processing units, or CPUs), such as a processor 704. Processor 704 may be connected to a communication infrastructure or bus 706.

Computer system 700 may also include user input/output device(s) 703, such as monitors, keyboards, pointing devices, etc., which may communicate with communication infrastructure 706 through user input/output interface(s) 702.

One or more of processors 704 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 may also include a main or primary memory 708, such as random access memory (RAM). Main memory 708 may include one or more levels of cache. Main memory 708 may have stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 may include a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 may read from and/or write to removable storage unit 718.

Secondary memory 710 may include other means, devices, components, instrumentalities or other approaches for allowing computer programs and/or other instructions and/or data to be accessed by computer system 700. Such means, devices, components, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 700 may further include a communication or network interface 724. Communication interface 724 may enable computer system 700 to communicate and interact with any combination of external devices, external networks, external entities, etc. (individually and collectively referenced by reference number 728). For example, communication interface 724 may allow computer system 700 to communicate with external or remote devices 728 over communications path 726, which may be wired and/or wireless (or a combination thereof), and which may include any combination of LANs, WANs, the Internet, etc. Control logic and/or data may be transmitted to and from computer system 700 via communication path 726.

Computer system 700 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 700 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

A tangible, non-transitory apparatus or article of manufacture comprising a tangible, non-transitory computer useable or readable medium having control logic (software) stored thereon may also be referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700 or processor(s) 704), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

### Conclusion

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method for loading a machine learning model into a camera system to detect a feature, comprising:
receiving, by at least one computer processor on a camera system, a command to download a machine learning model to the camera system, wherein the machine learning model is configured to detect a feature in a video stream;
downloading the machine learning model to the camera system;
installing the machine learning model on the camera system;
capturing a video stream;
detecting, using the machine learning model, the feature in the video stream; and
in response to the detecting, transmitting a camera detection notification indicating detection of the feature to a user device corresponding to a user account linked to the camera system.

2. The computer-implemented method of claim 1, further comprising:
setting a response command to perform a home automation action in response to detection of the feature in the video stream; and
transmitting, to a home automation system, the response command to perform the home automation action.

3. The computer-implemented method of claim 1, wherein the installing further comprises:
retraining the machine learning model using one or more images captured by the camera system, thereby modifying one or more parameters used by the machine learning model to detect the feature.

4. The computer-implemented method of claim 1, further comprising:
detecting, via the machine learning model, an unknown feature captured in the video stream;
presenting one or more frames of the video stream including the unknown feature to a system external to the camera system for classification of the unknown feature;
receiving a classification label corresponding to the unknown feature from the system external to the camera system;
transmitting, to the user device, a second camera detection notification including the classification label; and
retraining the machine learning model using the classification label to classify the unknown feature.

5. The computer-implemented method of claim 1, further comprising:
receiving data from a second camera system indicating detection of a second feature by a second machine learning model installed on the second camera system; and
transmitting a second response command to perform a second home automation action corresponding to detection of the feature in the video stream and the second feature.

6. The computer-implemented method of claim 1, wherein the feature is an appearance of a predefined object in the video stream.

7. The computer-implemented method of claim 1, wherein the feature is an absence of a previously detected object in the video stream.

8. The computer-implemented method of claim 1, wherein the feature is recognition of a semantic meaning corresponding to textual characters identified via natural language processing.

9. A camera system, comprising:
one or more cameras;
one or more memories; and
at least one processor each coupled to the one or more cameras and at least one of the memories and configured to perform operations comprising:
receiving a command to download a machine learning model to the camera system, wherein the machine learning model is configured to detect a feature in a video stream;
downloading the machine learning model to the camera system;
installing the machine learning model on the camera system;
capturing a video stream;
detecting, using the machine learning model, the feature in the video stream; and
in response to the detecting, transmitting a camera detection notification indicating detection of the feature to a user device corresponding to a user account linked to the camera system.

10. The camera system of claim 9, the operations further comprising:
setting a response command to perform a home automation action in response to detection of the feature in the video stream; and
transmitting, to a home automation system, the response command to perform the home automation action.

11. The camera system of claim 9, wherein the installing further comprises:
retraining the machine learning model using one or more images captured by the camera system, thereby modifying one or more parameters used by the machine learning model to detect the feature.

12. The camera system of claim 9, the operations further comprising:
detecting, via the machine learning model, an unknown feature captured in the video stream;
presenting one or more frames of the video stream including the unknown feature to a system external to the camera system for classification of the unknown feature;
receiving a classification label corresponding to the unknown feature from the system external to the camera system;
transmitting, to the user device, a second camera detection notification including the classification label; and
retraining the machine learning model using the classification label to classify the unknown feature.

13. The camera system of claim 9, the operations further comprising:
receiving data from a second camera system indicating detection of a second feature by a second machine learning model installed on the second camera system; and
transmitting a second response command to perform a second home automation action corresponding to detection of the feature in the video stream and the second feature.

14. The camera system of claim 9, wherein the feature is an appearance of a predefined object in the video stream.

15. The camera system of claim 9, wherein the feature is an absence of a previously detected object in the video stream.

16. The camera system of claim 9, wherein the feature is recognition of a semantic meaning corresponding to textual characters identified via natural language processing.

17. A non-transitory computer-readable medium having instructions stored thereon that, when executed by at least one computing device, cause the at least one computing device to perform operations comprising:
receiving, by at least one computer processor on a camera system, a command to download a machine learning model to the camera system, wherein the machine learning model is configured to detect a feature in a video stream;
downloading the machine learning model to the camera system;
installing the machine learning model on the camera system;
capturing a video stream;
applying the machine learning model to the video stream;
detecting, using the machine learning model, the feature in the video stream; and
in response to the detecting, transmitting a camera detection notification indicating detection of the feature to a user device corresponding to a user account linked to the camera system.

18. The non-transitory computer-readable medium of claim 17, the operations further comprising:
setting a response command to perform a home automation action in response to detection of the feature in the video stream; and
transmitting, to a home automation system, the response command to perform the home automation action.

19. The non-transitory computer-readable medium of claim 17, wherein the installing further comprises:
retraining the machine learning model using one or more images captured by the camera system, thereby modifying one or more parameters used by the machine learning model to detect the feature.

20. The non-transitory computer-readable medium of claim 17, the operations further comprising:
detecting, via the machine learning model, an unknown feature captured in the video stream;
presenting one or more frames of the video stream including the unknown feature to a system external to the camera system for classification of the unknown feature;
receiving a classification label corresponding to the unknown feature from the system external to the camera system;
transmitting, to the user device, a second camera detection notification including the classification label; and
retraining the machine learning model using the classification label to classify the unknown feature.
